(19) United States
(12) Patent Application Publication
(10) Pub. No.: US 2004/0061318 A1
(43) Pub. Date: Apr. 1, 2004

(54) Inflation device

(76) Inventor: Richard John Ord, Auckland (NZ)

Correspondence Address: YOUNG & THOMPSON, 745 SOUTH 23RD STREET 2ND FLOOR, ARLINGTON, VA, 22202

(21) Appl. No.: 10/450,173

(22) PCT Filed: Dec. 11, 2001
(86) PCT No.: PCT/NZ01/00276

(30) Foreign Application Priority Data
Dec. 11, 2000 (NZ) 508792

(51) Int. Cl. B60R 21/26

(52) U.S. Cl. 280/737

(57) ABSTRACT

An inflation device for storing and releasing pressurized fluid includes a substantially donut shaped cylinder (2) containing the pressurized fluid. An activation system (4) includes a trigger mechanism (6) positioned within a cavity (8) formed by the donut shaped cylinder (2). The cylinder (2) includes at least one puncturing zone (3) in contact with the pressurized fluid, the puncturing zone (3) including a sealing element (33) seated on a valve member inside the puncturing zone (3), the sealing element (33) connected to a puncturing rod (31). When activated, the trigger mechanism (6) actuates the puncturing rod (31), driving the sealing element (33) off the valve member thereby allowing the pressurized fluid to flow out of the cylinder (2) past the sealing element (33) and through the puncturing zone (3).

### TECHNICAL FIELD

The present invention relates to a mechanical device and system that, by activation means, releases compressed gas. It has particular application to safety air bag systems installed in motor vehicles,

### BACKGROUND ART

Air bags commonly utilise a pyrotechnic-type of inflation device in which, when activated by the detection of a pre-selected deceleration, two chemicals are mixed, and produce a gas. It is this gas that inflates the air bag. The reaction between the two chemicals is exothermic, and produces excess amounts of hot gas, which is released through “vent” holes in the air bag surface. The release of this hot gas from the air bag has been known to cause severe burns to the recipient. The air bag must also be composed from a heat resistant fabric to prevent it from melting when inflated.

Mechanical devices, using compressed air, have been contemplated as an alternative to pyrotechnic-type inflation devices. WO 99/14077 discloses a mechanical air bag inflation device, which uses two compressed air cylinders. However, the design and precise mechanism of this device provide a relatively slow reaction time (substantially 49 milliseconds, following activation, to fill a 55 litre air bag), The design of the piercing pin used to puncture the cylinder requires two movements before gas can be released from the cylinder; an inward movement to break the seal on the cylinder and an outward movement to release the gas from the cylinder via the piercing pin vent holes. In some cases the time taken to perform these two movements meant that the air bag was not fully inflated at the point of recipient impact on the air bag surface. The small size of the vent holes has also limited gas flow rates and therefore inflation times.

Other mechanical devices, such as that disclosed in WO 94/18035, may also have an undesirably long reaction time. The shape of this type f device and number of air cylinders required to fill an air bag substantially increase the complexity of the device and the time taken to inflate the air bag.

It is an object of the present invention to overcome or ameliorate at least one of the disadvantages of the prior art, or at least to provide a useful alternative.

### DISCLOSURE OF THE INVENTION

According to one aspect of the present invention there is provided an inflation device including;

a substantially donut shaped cylinder containing a pressurised fluid;

an activation system including a trigger mechanism positioned within a cavity formed by the donut shaped cylinder;

at least one puncturing zone in contact with said pressurised fluid, the puncturing zone including a sealing means seated on a valve member, the sealing means connected to or integrally associated with a puncturing rod a distal end of which is substantially adjacent said trigger mechanism;

wherein, when activated, said trigger mechanism actuates said puncturing rod, driving said sealing means off said valve member thereby allowing said, pressurised fluid to flow out of said cylinder past said sealing means and through said puncturing zone.

Preferably said sealing means may be seated on a substantially ring shaped seat.

Preferably said sealing means may be a substantially frustro-conical shaped member.

Preferably said trigger mechanism may include a puncturing trigger including a cam portion and an opposite notched portion to engage a fixing holder.

Preferably said trigger mechanism may be activated by an ascent/descent rod.

Preferably said puncturing rod and /or said sealing means may be acetal, nylon, teflon or any other high density plastic.

Preferably said activation system may be activated on detection of a pre-selected acceleration or deceleration.

Preferably said activation system may be activated by a sensor.

Preferably said activation system may be activated by a user.

Preferably said pressurised fluid may be substantially air.

Preferably said pressurised fluid may be substantially nitrogen or carbon dioxide.

Preferably said trigger mechanism may include a cam portion.

Preferably said valve member may be in fluid communication with an inflatable member.

Preferably said inflatable member may be a buoyancy compensation device.

Preferably said inflatable member may be a life boat.

Preferably said inflatable member may be an air bag.

Preferably said air bag may be adapted to substantially seal a pipe or drain.

According to a second aspect of the present invention there is provided a mechanical air bag inflation device including;

a substantially donut shaped cylinder;

at least one puncturing zone on the surface of the cylinder;

an activation system positioned within a cavity formed by the donut shaped cylinder, and which is responsive to a pre-selected acceleration or deceleration;

wherein the activation system releases the cylinder's content via the puncturing zone when the pre-selected acceleration or deceleration is met.

Preferably the activation system may include a sensor responsive to a pre-selected acceleration or deceleration; a trigger mechanism which may be activated and/or moveable when the pre-selected acceleration or deceleration is detected; and a puncturing mechanism which may allow release of the content of said cylinder via the puncturing zone following stimulus from the trigger mechanism.

Preferably the activation system may include a sensor, including a counter balance, responsive to a pre-selected inertial force; a trigger mechanism which may be activated and/or moveable when the counter balance pre-selected inertial force is met; and a puncturing mechanism which may allow release of the content of said cylinder via the puncturing zone following stimulus from the trigger mechanism.

Preferably the puncturing mechanism may include a puncturing housing and a puncturing rod; said puncturing housing including a sealing means seated on a valve member which forms the puncturing zone, said sealing means connected to the puncturing rod.

Preferably the puncturing housing may be connected to an air bag, such that following activation the content of the cylinder is released via the valve member of the puncturing housing into the air bag.

Preferably the trigger mechanism may convert the activation of the sensor to a longitudinal driving force on said puncturing rod.

According to a further aspect of the present invention there is provided a mechanical air bag inflation system including;

a donut shaped cylinder;

at least one puncturing zone on the surface of the cylinder;

an activation system, positioned within a cavity formed by the donut shaped cylinder, and which is responsive to a pre-selected acceleration or deceleration;

and an air bag in fluid communication with the puncturing zone;

wherein when the pre-selected acceleration or deceleration is met, the activation system releases the content of the cylinder through the puncturing zone to substantially inflate said air bag.

Preferably the activation system may include a sensor responsive to a pre-selected acceleration or deceleration; a trigger mechanism which may be activated and/or moveable when the pre-selected acceleration or deceleration is detected; and a puncturing mechanism which may allow release of the content of said cylinder via the puncturing zone following stimulus from the trigger mechanism.

Preferably the activation system may include a sensor, including a counter balance, responsive to a pre-selected inertial force ; a trigger mechanism which may be activated and/or moveable when the counter balance pre-selected inertial force is met; and a puncturing mechanism which may allow release of the content of the cylinder via the puncturing zone, following stimulus by the trigger mechanism.

Preferably the puncturing mechanism may include a puncturing housing and a puncturing rod and said puncturing housing may include a sealing means seated on a valve member which forms the puncturing zone, said sealing means connected to the puncturing rod.

Preferably said air bag may be secured to the puncturing housing such that following activation, the content of the cylinder is released via the valve member into said air bag.

According to a still further aspect of the present invention there is provided a mechanical air bag inflation device including;

a cylinder;

at least one puncturing zone on the surface of the cylinder;

an activation system which is responsive to a pre-selected acceleration or deceleration and wherein the activation system includes a puncturing rod which requires only one movement to puncture the puncturing zone and release the content of the cylinder.

Preferably the activation system may further include a sensor including a counter balance, responsive to a pre-selected inertial force; a trigger mechanism which may be activated and/or moveable when the counter balance pre-selected inertial force is met; and a puncturing mechanism including a puncturing rod.

Preferably the puncturing mechanism may further include a puncturing housing; said puncturing housing may include a sealing means seated on a valve member which forms the puncturing zone, said sealing means connected to the puncturing rod.

Preferably the trigger mechanism converts the activation of the sensor, to the pre-selected acceleration or deceleration, to the puncturing rod of the puncturing mechanism.

According to a further aspect of the invention there is provided an air bag inflation device substantially as herein described and with reference to the accompanying drawings.

According to a further aspect of this invention there is provided an air bag inflation system substantially as herein described and with reference to the accompanying drawings.

Further aspects of the present invention, which should be considered in all its novel aspects, may become apparent from the following description, given by way of example only and with reference to the accompanying drawings.

### BRIEF DESCRIPTION OF THE DRAWINGS

The invention will now be described by way of example only and with reference to the drawings in which: FIG. 1: Shows an exploded view of an inflation system according to on embodiment of the present Invention.

FIG. 2: Shows a simplified sectional plan view of a trigger mechanism in a “loaded” condition, according to a second embodiment of the present invention;

FIG. 3 Shows a simplified sectional side view of a trigger mechanism in a “loaded” condition, according to a second embodiment of the present invention;

FIG. 4: Shows a simplified sectional side view of the puncturing zone and mechanism according to a further embodiment of the present invention.

### BEST MODE FOR CARRYING OUT THE INVENTION

In this specification the term “cavity” is used to refer to the central opening formed by a donut shape. The term “content” is intended to include standard pressurised air, and/or a pressurised inert gas, such as pressurised nitrogen or carbon dioxide. The word “donut” refers to a torus geometric shape. The “loaded” form is intended to refer to the device set for activation, which may be activated by a pro-selected inertial force or manually by a user. The term “inertial force” Is intended to refer to the reaction force which a first body exerts on a second body which is trying to accelerate or decelerate said first body, the force being directly proportional to said acceleration or deceleration. The “puncturing zone” refers to the site at which the cylinder releases the content of the cylinder.

This present invention will now be described with reference to its use as an air bag inflation device in a motor vehicle.

FIG. 1 illustrates an exploded view of an inflation device, generally referenced by arrow 100, according to one preferred embodiment of the Invention. The inflation device 100 may include a substantially donut shaped steel cylinder 2, a puncturing zone on the cylinder 3 or at least in contact with the contents of the cylinder 2, and an activation mechanism 4. The activation mechanism includes a acceleration/deceleration sensor 5, a trigger mechanism 6, and a puncturing mechanism 7. It should be understood that the description presented below and with reference to the drawings, represents an embodiment of the invention in a “loaded” state.

The unique donut shape may allow the cylinder 2 to hold a greater capacity then some of the linear cylinders disclosed in the prior art. As such, only one cylinder 2 may be necessary to fill an air bag. The cylinder 2 may be filled with gas to a varying capacity depending on the function for a particular device and/or where the device is to be positioned in a vehicle. Some air beg inflation mechanisms of the prior art have required at least two linear cylinders to fill a 55 litre drivers air bag. By contrast the present invention may require only one cylinder 2 to fill an air bag of a substantially similar or even larger size . It will be appreciated that more donut shaped cylinders 2 may be incorporated with this invention depending on the intended use for a specific inflation device.

It will also be recognised by those skilled in the art that the exact size and/or diameter of the cylinder 2 may be varied according to the vehicle in which the device is to be installed, without departing from the scope or spirit of the invention. The size and/or diameter may also depend on where the device is designed for installation. A device may be positioned, for example, in a passenger zone, a side intrusion zone, a knee protection zone, a rear seat passenger zone, or a drivers zone and the size and/or diameter of the cylinder 2 may vary accordingly, However, as the diameter of the cylinder 2 dictates the diameter of the overall device, the cylinder diameter should be appropriate for the circumstances. The cylinder 2 may, for example, be sized to fit into a steering wheel frame.

In the preferred form the cylinder 2 may be composed from stainless steel. However, plastics, metal alloys or any other material of a suitable quality and strength may be used.

The central cavity 8 created by the donut shaped cylinder 2, is adapted to accommodate the activation device 4. The central cavity 8, in the preferred form, may be covered by a top panel 9, which primarily acts to protect the trigger 6 and puncturing mechanisms 7 in the central cavity 8. A base plate 10, on the under surface of the device, may cover the under surface of the central cavity 8 and provide a base on which the activation mechanism 4 may be attached.

In this particular embodiment, a sensor 5, which detects acceleration or deceleration, may include a weight 11 and a counter balance arm 12. The counter balance arm 12 may be substantially “L” shaped, although in alternative embodiments the counter balance arm 11 may be substantially flat. The weight 11 may be suspended at one end of the arm 12, whilst at the other end the arm is connected to the top panel 9 by a hinge 13. The weight 11 is fixedly secured at the end of the long section of the counter balance arm 12, by screws 14 or any suitable fasteners.

The acceleration/deceleration sensor 5 may be suspended above the top panel 9 by the combined force of the hinge 13, and a spring 15 positioned between the top panel 9 and the counter balance arm 12. This spring may provide resistance to downward pressure and/or depression of the counter balance arm 12.

An additional spring (not shown) may be positioned substantially in the centre of the counter balance arm 12, and held in place by a screw. This spring may substantially prevent movement of the counter balance arm 12 due to minor vibrations caused by normal operation of the vehicle, which may in turn assist in preventing inappropriate inflation of the air bag.

The spring 15 may be held in place, under the counter balance arm 12, by an ascent/descent rod 18. The ascent/descent rod 18 forms part of the trigger mechanism 6. The top panel 9 may provide a guide for the ascent/descent rod 18 which may make contact with the under surface of the counter balance arm 12.

The ascent/descent rod 18 engages a fixing holder 19. The fixing holder 19 may include a back plate 20 and a roller stub 21. The back plate 20 may be adjacent to a guide panel 22. In one embodiment the guide panel 22 houses at least two rollers 23a which allow near frictionless downward movement of the back plate 20, and thus the fixing holder 19, following downward movement of the ascent/descent rod 18.

The roller stub 21 of the fixing holder 19 houses at least one roller 23b. The roller stub 21 makes contact with a notch 24 on the under surface of a puncturing trigger 25 via the roller 23B.

The puncturing trigger 25 is suspended horizontally within a vertically positioned firing spring 26, which is separated Into upper and lower-parts (26a and 26b). A central shaft 27 passes vertically through the horizontal top panel 9, the centre of the spring 26 and the puncturing trigger 25, and is fixedly connected to the base plate 10. This aligns the spring 26 and the puncturing trigger 25 vertically. A groove and/or depression on the under surface of the top panel 9, and the top surface of the base plate 10 provide a seat for the spring 26, and aid its permanent alignment (not shown). The two coiled parts of the spring 26a, 26b may be connected by a straight portion 28.

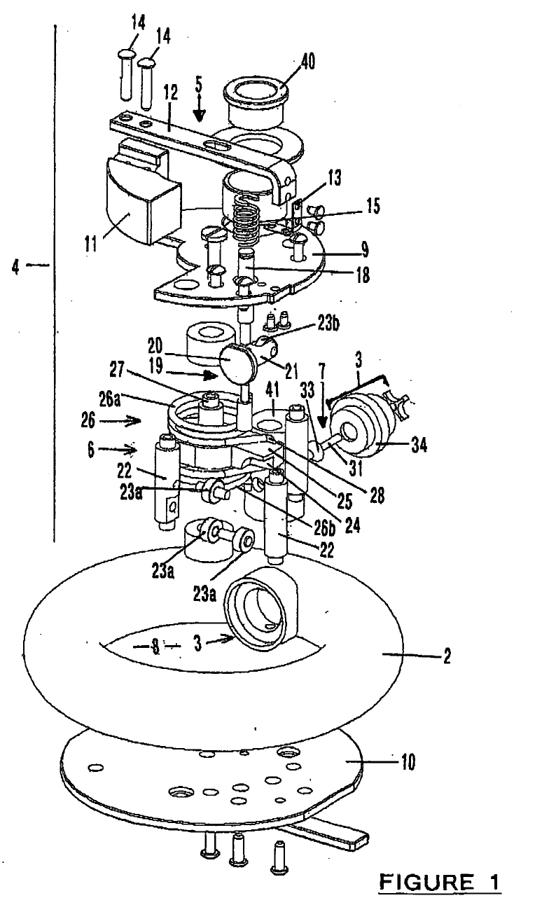

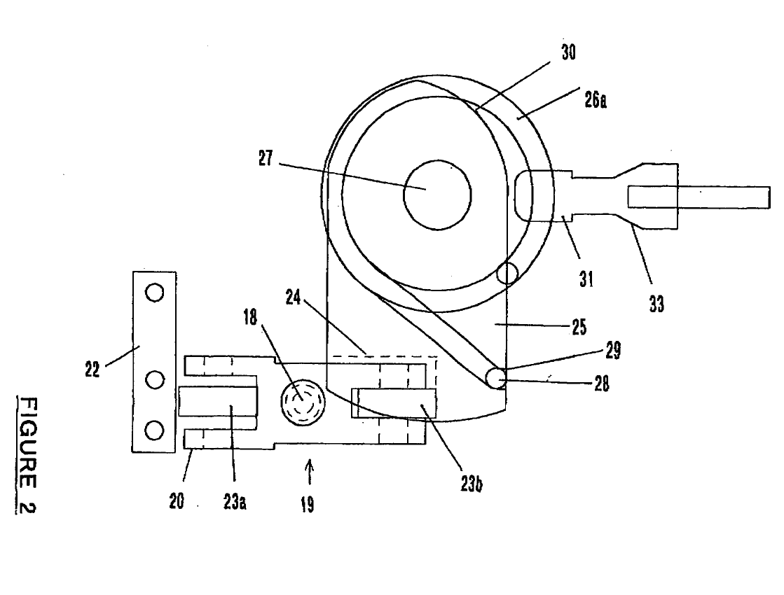

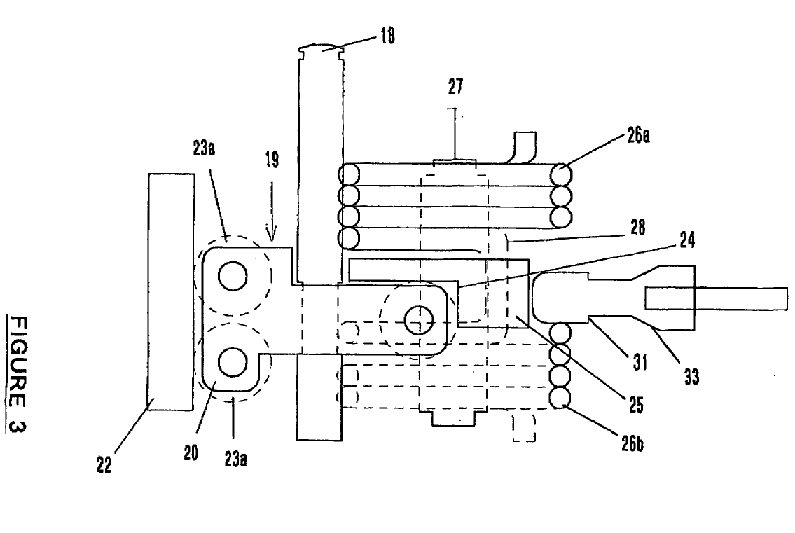

FIGS. 2 and 3 show a preferred embodiment of the invention wherein the rollers 23A have been relocated from the guide panel 22 to the backplate 20. The puncturing trigger 25 is designed to fit between the two parts 26a, 26b of the firing spring 26. The straight portion 28 fits into a slot 29 in the puncturing trigger 25 and, when activated, provides a force to drive a clockwise movement of the puncturing trigger 25 about the central shaft 27.

The puncturing trigger 25 has a contoured portion 30 such that when activated, that is, when the ascent/descent rod 18 pushes the fixing holder 19 below the notch 24 in the puncturing trigger 25, the clockwise movement of the puncturing trigger 25 causes the contoured portion 30 to contact a puncturing rod 31 in the manner of a cam.

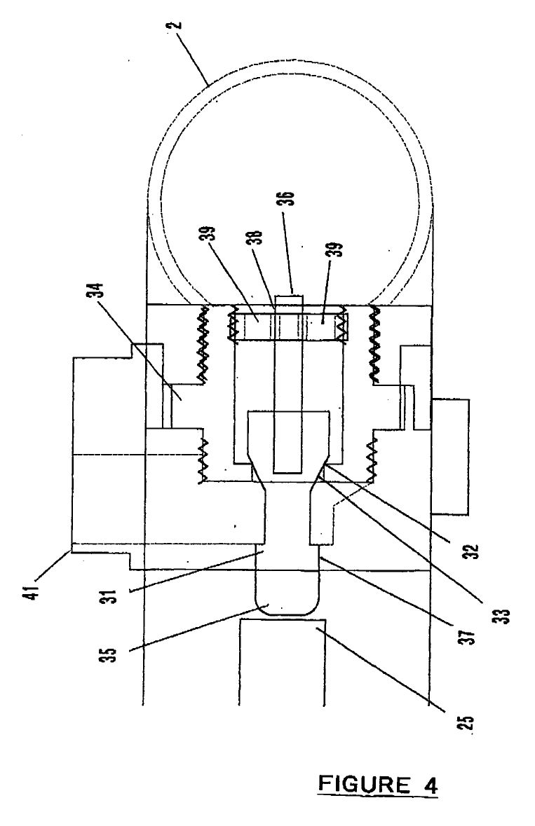

Referring next to FIGS. 1 and 4, in this particular embodiment of the invention, only one puncturing zone 3 is required due to the use of a single donut shaped cylinder 2. The puncturing mechanism 7 may include a puncturing rod 31, a valve seat 32 and a sealing means 33. In a preferred embodiment the valve seat 32 and/or sealing means 33 may be manufactured from acetal or any other suitable high density plastic such as teflon or nylon. The valve seat 32 may be part of a valve member 34 or may be a separate insert. The seat 32 may be tapered or flat. In the present embodiment the sealing means 33 may be a substantially frustro-conical shaped member, although other configurations, such as, for example a substantially flat ring may be used.

The puncturing rod 31 may act on the activation signal from the puncturing trigger 25 to release the content of the cylinder 2. The puncturing rod 31 may include a trigger striking end 35, positioned substantially outside the valve member 34, and in substantially close proximity to the puncturing trigger 25. The opposite and 36 of the puncturing rod 31 may protrude into the cylinder 2. The puncturing rod 31 may be solid and may be formed from hardened steel, brass, high density plastic or any other suitable material.

It will be understood by those skilled in the art that the puncturing housing 41 has a dual role. It is designed to both allow the activation signal to be transmitted, and to direct the content of the cylinder 2 into the air bag once released.

When the content of the cylinder 2 is pressurised, for example pressurised air, the sealing means 33 of the puncturing rod 31 may be forced against the valve seat 32. In a preferred form the valve seat 32 may include an acetal ring. A spring (not shown), positioned on the puncturing rod 31 may provide additional resistance to movement of the sealing means 33 off the valve seat. The long term sealing characteristics of this mechanism may be particularly favourable and the cylinder may stay pressurised for longer than prior art systems which use rubber O-rings for sealing, due to the low air permeability of plastics such as acetal compared to rubber.

In the embodiment shown in FIG. 4, there is no specific seal on the puncturing rod 31, at the junction point between the puncturing housing 41 and the external environment. The diameter of the hole 37 in the housing 34 that the puncturing rod 31 passes through, is substantially the same diameter as the puncturing rod 31. However, the hole 37 allows free and almost frictionless movement of the puncturing rod 31. Therefore the puncturing housing 41 is somewhat sealed from the external environment, whilst the sealing means 33 substantially seals the content of the cylinder 2 prior to activation.

Within the valve member 34 the puncturing rod 31 is held in alignment by a support 38.

Referring back to FIGS. 1, 2 and 3, in the event of an accident, the vehicle, and therefore the inflation device 1 may experience a rapid deceleration. The counter weight 11 may be decelerated by a force provided by the counter balance arm 12 and may in turn provide an equal and opposite inertial force on the counter balance arm 11. The pre-selected inertial force may be calculated as the product of the mass of the counter weight 11 and the critical deceleration above which the sensor mechanism 5 is intended to deploy.

In operation, when the pro-selected inertial force overcomes the resistance of the spring 15, the counter balance arm 12 may tilt from the hinge 13 initiating activation. This substantially downward movement of the counter balance arm 12 may lower the ascent/descent rod 18, which in turn may vertically lower the fixing holder 19, allowing the puncturing trigger 25 to rotate. The force created by the wound firing spring 26 acts through the straight portion 28 on the slot 29 of the puncturing trigger 25 and rotates the puncturing trigger 25 clockwise about the central shaft 27, by substantially 180° (as viewed from the top face (FIG. 2). This movement allows the cam profile 30 of the puncturing trigger 25 to make contact with the trigger striking end 35 of the puncturing rod 31.

Referring next to FIG. 4, contact from the puncturing trigger 25, pushes the puncturing rod 31 horizontally outwards or towards the cylinder 2. This outward movement of the puncturing rod 31 displaces the airtight seal formed between the sealing means 33 and the valve seat 32, The opening, formed between the sealing means 33 and the seat 32, is held open by pressure exerted on the puncturing rod 31 by the cam profile (30). The content of the cylinder 2 passes through internal apertures 39 in the housing 34, then flows from the valve member 34 through the puncturing housing 41 to a fitting 40 which protrudes from the top panel 9, to connect to an air bag. In practise a small amount of fluid may pass through the clearance gap between the hole 37 in the puncturing housing 41 and the puncturing rod 31, but the amount of fluid lost may be negligible as the restriction to flow is much greater than that provided by the path through the fitting 40 to the airbag.

In alternative embodiments, for example a passenger airbag, the fixing holder 19 and associated trigger mechanism may be replaced by an electronic solenoid actuated by a signal provided by an acceleration detection device, for example an electronic accelerometer or a signal from the drivers side airbag. This may allow the passenger airbag to be deactivated if no passenger is seated in the vehicle.

In still further embodiments the ascent/descent rod 18 may be activated by a user, either directly or by an intermediate mechanism, for example if the inflation device is used to inflate a divers buoyancy compensation device or a lifeboat. In another embodiment the mechanism of the present invention may be part of a system which utilises an inflated bag or bladder for plugging pipes or drains.

In still another embodiment a solenoid may replace the entire activation mechanism shown and may act directly on the puncturing rod to activate the valve.

The time taken from the initiation of activation to complete inflation of a 55 litre air bag may, in some cases, be substantially 46 milliseconds. This may be up to substantially 3.8 milliseconds faster than some mechanical devices disclosed in the prior art take to fill a similar size air bag.

The reduction of time, from initiation to inflation, may be primarily due to single valve allowed by use of the donut shaped cylinder as well as the simplified activation mechanism. In particular the valve arrangement of the present invention does not require a puncturing member to be inserted then withdrawn before the content of the cylinder can begin to flow. The area between the sealing means and the seat, through which the cylinder content may flow, may be substantially larger than the flow area created by a pin piercing a membrane.

The use of a mechanical device to inflate air bags may reduce the requirement for thick heat resistant fabrics that are currently in use with pyr technic-type inflation devices. This may, in turn, reduce the cost of manufacturing an air bag safety device.

It will be understood by those skilled in the art that the present air bag inflation device could be installed in new vehicles, or provided as a system that may be installed in older vehicles. It will also be appreciated that a device of this nature may have broader applications to the transportation industry, for example in trains, buses, aircraft or powerboats.

Although the invention has been described with reference to the inflation of air bags, it is to be understood that a mechanical device of this nature could have applications in other fields where the immediate release of a gas is required. This may include, the inflation of lifeboats, and/or any other marine life preservation system.

Where in the foregoing description reference has been made to specific components or integers of the invention having known equivalents then such equivalents are herein incorporated as if individually set forth.

Although this invention has been described by way of example and with reference to possible embodiments thereof, it is to be understood that modifications or improvements may be made thereto without departing from the scope of the appended claims,

1. An inflation device including:
a cylinder containing a pressurised fluid;
an activation system including a trigger mechanism positioned within a cavity formed by the cylinder;
at least one puncturing zone in contact with said pressurised fluid, the puncturing zone including a sealing means seated on a valve member, the scaling means connected to a puncturing rod a distal end of which is substantially adjacent said trigger mechanism;
wherein, when activated, said trigger mechanism actuates said puncturing rod, driving said sealing means off said valve member, thereby allowing said pressurised fluid to flow out of said cylinder past said valve member and through said puncturing zone.

2. The inflation device of claim 1 wherein said sealing means may be seated on a substantially ring shaped scat.

3. The inflation device of claim 1 or 2 wherein said sealing means is substantially frustro-conical shaped member.

4. The inflation device of claim 1, 2 or 3 wherein said trigger mechanism may include a puncturing trigger including a camp portion and an opposite notched portion to engage a fixing holder.

5. The inflation device of claim 4 wherein said trigger mechanism may be activated by an ascent/descent rod.

6. The inflation device of claims 1 to 5 wherein said puncturing rod and/or said sealing means is acetal, nylon, teflon or any other high density plastic.

7. The inflation device of any one of claims 1 to 6 wherein said activation system is activated on detection of a pre-selected acceleration or deceleration.

8. The inflation device of any one of claims 1 to 7 wherein said activation system is activated by a sensor.

9. The inflation device of any one of claims 1 to 6 wherein said activation system is activated by a user.

10. The inflation device of any one of the previous claims wherein said pressurised fluid is substantially air.

11. The inflation device of any one of claim 1 to 9 wherein said pressurised fluids is substantially nitrogen or carbon dioxide.

12. The inflation device of any one of the previous claims wherein said valve member is in fluid contact with an inflatable member.

13. The inflation device of claim 12 wherein said inflatable member is a buoyancy compensation device.

14. The inflation device of claim 12 wherein said inflatable member is a life boat.

15. The inflation device of claim 12 wherein said inflatable member is an air bag.

16. The inflation device of claim 5 wherein said air bag is adapted to substantially seal a piper or drain.

17. A mechanical air bag device including;
a cylinder;
at least one puncturing zone on the surface of the cylinder;
an activation system positioned within a cavity formed by the cylinder, and which is responsible to a pre-selected acceleration or deceleration;
wherein the activation system includes a trigger mechanism which is adapted to stimulate a puncturing mechanism when the pre-selected acceleration or deceleration is detected or met, the puncturing mechanism, being adapted to release the cylinder's content via the puncturing zone.

18. The air bag inflation device of claim 17 wherein said activation system includes a sensor responsive to a pre-selected acceleration and/or deceleration; a trigger mechanism which is activated and/or moveable when pre-selected acceleration and/or deceleration is detected; and a puncturing mechanism which allows release of the content of said cylinder via the puncturing zone following stimulus from the trigger mechanism.

19. The air bag inflation device of claim 17 wherein said activation system includes a sensor, including a counter balance, responsive to a pre-selected inertial force; a trigger mechanism which is activated and/or moveable when the counter balance pre-selected inertial force is met; and a puncturing mechanism which allows the release of the content of said cylinder via the puncturing zone following stimulus from the trigger mechanism.

20. The air bag inflation device of claim 18 or 19 wherein the puncturing mechanism may include a puncturing housing and puncturing rod; said puncturing housing including a sealing means seated on a valve member which forms the puncturing zone, said scaling means connected to the puncturing rod.

21. The air bag inflation device of claim 20 wherein the puncturing housing is connected to an air bag, such that following activation the content of the cylinder is released via the valve member of the puncturing housing into the air bag.

22. The air bag inflation device of any one of any one of claims 18 to 21 wherein the trigger mechanism converts the activation of the sensor to a longitudinal driving force on said puncturing rod.

23. A mechanical air bag inflation system including;
a cylinder;
at least one puncturing zone adjacent to the surface of the cylinder;
an activation system including a trigger mechanism and a puncturing mechanism positioned within a cavity formed by the cylinder, and which is responsive to a pre-selected acceleration or deceleration;
an air bag in fluid communication with the puncturing zone;
wherein when the pre-selected acceleration or deceleration is selected or met, the trigger mechanism is activated to stimulate the puncturing mechanism which releases the content of the cylinder through the puncturing zone to substantially inflate said air bag.

24. The air bag inflation system of claim 23 including a sensor responsive to a pre-selected acceleration or deceleration; trigger mechanism which is activated and/or moveable when the pre-selected acceleration or deceleration is detected; and a puncturing mechanism which may allow release of the content of said cylinder via the puncturing zone following stimulus from the trigger mechanism.

25. The air bag inflation system of claim 23 including a sensor which includes a counter balance responsive to a pre-selected inertial force; a trigger mechanism which is activated and/or moveable when the counter balance pre-selected inertial force is met; and a puncturing mechanism which allows release of the content of the cylinder via the puncturing zone, following stimulus by the trigger mechanism.

26. The air bag inflation system of claim 24 to 25 wherein the puncturing mechanism includes a puncturing housing and a puncturing rod and said puncturing housing may include a sealing means seated on a valve member which forms the puncturing zone, said scaling means connected to the puncturing rod.

27. The air bag inflation system of claim 26 wherein said airbag is secured to the puncturing housing such that following activation, the content of the cylinder is released via the valve member into said air bag.

28. A mechanical air bag inflation device including;
a cylinder,
at least one puncturing zone on the surface of the cylinder,
an activation system which is responsive to a pre-selected acceleration or deceleration and wherein the activation system includes a puncturing rod which requires only one movement to puncture the puncturing 7,one and release the content of the cylinder.

29. The air bag inflation device of claim 28 further including a sensor which includes a counter balance, responsive to a pre-selected inertial force; a trigger mechanism which is activated and/or moveable when the counter balance pre-selected inertial force is met; and a puncturing mechanism including a puncturing rod.

30. The air bag inflation system of claim 29 further including a puncturing housing; said puncturing housing including a sealing means seated on a valve member which forms the puncturing zone, said valve member connected to the puncturing rod.

31. The air bag inflation system of claim 29 or 30 wherein the trigger mechanism converts the activation of the sensor, to the pre-selected acceleration or deceleration, to the puncturing rod of the puncturing mechanism.

32. An inflation device substantially as herein described and with reference to the accompanying drawings.

33. An air bag inflation system substantially as herein described and with reference to the accompanying drawings.
